(19) United States
(12) Patent Application Publication
(10) Pub. No.: US 2003/0104154 A1
(43) Pub. Date: Jun. 5, 2003

(54) Label material

(76) Inventors: Thomas Lynn Brandt, Windsor, NY (US); Patrick Johannes Blom, Leiden (NL); Roger W. Sears, Green, NY (US)

Correspondence Address: Pearne & Gordon, Suite 1200, 526 Superior Avenue East, Cleveland, OH, 44114-1484, US

(21) Appl. No.: 10/203,110

(22) PCT Filed: Feb. 7, 2001
(86) PCT No.: PCT/NL01/00100

(30) Foreign Application Priority Data
Feb. 8, 2000 (EP) 002004166

(51) Int. Cl. B32B 9/00

(52) U.S. Cl. 428/40.1; 428/346

(57) ABSTRACT

The invention is directed to a label material at least comprising an image layer and an adhesive layer, wherein said adhesive layer is provided with at least one inorganic particulate material having a particle size not exceeding 50 μm and having a refractive index of between 1.4 and 1.6.

The present invention is directed to a label material comprising at least an image layer and an adhesive layer, wherein said adhesive layer is based on a pressure sensitive adhesive and/or a heat activatable adhesive.

Label bonding materials are currently extensively in use for applying labels to all kinds of surfaces, such as glass and plastic bottles, crates, other kinds of containers, and various surfaces. Quite often these labels are applied to the surfaces using high speed label applicators, such as those used for labelling bottles. These labels are currently applied either from a carrier web in the form of a roll, wherein the labels to be applied are transferred from a backing sheet on a roll to the desired surface, or from a stack of labels in a magazine. The label materials used in these applications are generally of the type, wherein a pressure sensitive or heat activatable adhesive is used to adhere the image to the surface.

In these high speed applications of labels to surfaces, important considerations are the blocking of labels and build up of static electricity, resulting in imperfect transfer, and/or even the interruption of the application process. A label material that would have no or a decreased static build up and/or blocking would accordingly be highly desirable.

Another aspect of the labelling process, sometimes causing concern, is the influence of water present on the surface to be labelled. Quite often labels are applied to surfaces that are still slightly wet or under conditions whereby condensation of water may occur. Without specific preventional measures, these conditions may result in imperfect label application and hence a diminished label quality. As such a label material with water repellent properties would be highly useful in the packaging industry.

There is an increasing use of high quality label materials for the so-called ‘ink-only’ type label applied using image transfer techniques, like described in WO-A 9005088 and WO-A 9005353. Other embodiments of the image transfer system are disclosed in WO-A 9734810, WO-A 0735292, WO-A 9735291 and WO-A 9735290. When using these techniques in conjunction with transparent or semi-transparant labels it is often a problem that even the best, clear adhesives tend to be visible in the label as applied, causing a slight haze (lack of clarity). Further, it is common to have some adhesive extending beyond the edges of the label print, which may show on the surface, possibly detracting from the quality of the overall appearance of the label.

Also in the case of labels based on transparent or semi-transparant films, the phenomenon of haze can occur, because of the poor clarity of the film itself, or the influence of the adhesive. Accordingly there is a need for improvement in this area.

The present invention provides for improvements in the above areas, more in particular the present invention provides for label materials that show decreased or even no blocking and/or static build up, have water repellent properties, whereas the clarity tends to be enhanced also. Further the labels, as applied onto the surface of the article have a better hardness, resulting in improved scratch resistance properties, and show better adhesion characteristics.

The present invention is based on the surprising insight, that it is possible to reach these goals by the use of a material utilised in conjunction with the adhesive layer of a label that promotes improved clarity, reduces static built up and blocking problems, and overcomes surface moisture induced problems, during high speed labelling operations of containers.

Accordingly the invention is directed to a label material at least comprising an image layer and an adhesive layer, wherein said adhesive layer is provided with at least one inorganic particulate material having a particle size not exceeding 50 μm and having a refractive index of between 1.4 and 1.6.

Even though other materials may provide a similar refractive index, the uniqueness of the combined characteristics of label clarity (refractive index), ability to separate and to provide water repellancy, combined in one material makes it ideal for numerous high speed label applications.

The invention provides for labels, when applied to the substrate, having a clarity (defined in Nephelomotric Turbidity Units) that is al least the same or better than the material without the said inorganic particulate material.

According to the invention the inorganic material is present on or mixed within the adhesive layer. It is possible to have the material present in a homogeneous mixture with the adhesive. This can be done by mixing the inorganic material with the molten and/or liquid adhesive, prior to applying the said adhesive on the label substrate or carrier web. It is also possible to have the material only on the surface of the adhesive, or concentrated only in the side of the adhesive layer that will be attached to the surface of the article to be labelled. This condition can be reached by applying the inorganic material to the outer surface of the adhesive, for example by dusting, vacuum deposition, electrostatic deposition or similar other technique.

In an alternative embodiment a separate, thin layer of the adhesive, having the inorganic material mixed in it homogeneously, can be applied on the adhesive layer containing no inorganic material. In that way the inorganic material is concentrated on the side of the label material that will be adhered to the surface of the desired article.

The label material according to the invention may be applied to the surface in a conventional manner, however, consideration should be given to the water repellent characteristics of the label, which will result in less restrictive measures with respect to drying and/or preventing condensation. This is especially of importance with regard to labelling glass bottles, which is usually aone in the filling plant, after cleaning and filling the bottles. Accordingly there is generally a certain level of residual moisture present on the container surface and the conditions in the filling line in general tend to be rather humid.

The type of label applicator will depend on the type of label, more in particular the nature of the adhesive (pressure sensitive or heat activatable) and style of application system used (magazine fed or reel to reel).

The inorganic material, which can be of natural or synthetic origin, has to meet the criteria of mean particle size and refractive index, as otherwise the objectives are not, or only partly met. The mean particle size can be determined using conventional techniques, such as laser sizer or Coulter counter. The refractive index is determined at 20° C., using Sodium D light, using a conventional refractometer, such as an Abbe refractometer.

Additionally it is preferred that the material be based on silicon dioxide and/or silicate containing materials. Examples thereof are silica (optionally modified) and silicates, like zeolites or natural and synthetic clays. Most preferred is diatomaceous earth material, such as sold under the tradename Celite.

The particle size of the material is preferably between 0.5 and 25 μm, whereas the amount of the material in the adhesive preferably varies between 0.00001 and 1 g/square inch. In this respect it is to be noted that the amount depends also on the way the material is distributed in/over the adhesive layer. In the case the material is mixed homogeneously through the adhesive, the amount will be in the higher than in case of the adhesive being present in the outer layer only, whereas in case of the material being present on the surface only, the amount will be the lowest. More in particular, the amounts mixed homogeneously will be preferably be between 0.001 and 0.005 g. (inch)⁻², whereas the amounts applied only on the surface will preferably be between 0.0001 and 0.0025 g. (inch)⁻².

The label material according to the invention is preferably based on image transfer and/or no-label-look systems.

In the context of the present invention the term image transfer is used in one embodiment as a labelling system, wherein a removable backing layer is reversed printed with a suitable ink and subsequently overprinted with adhesive. A general disclosure of this technique is for example disclosed in WO-A 9005088 and WO-A 9005353. Other embodiments of the image transfer system are disclosed in WO-A 9734810, WO-A 0735292, WO-A 9735291 and WO-A 9735290, the contents of all six applications is incorporated herein by way of reference.

The term ‘no-label-look’ refers to ‘Applied Pressure-sensitive Label’ (APL) and/or heat activated film transfer systems such as disclosed in WO-A 9005088.

### DETAILED DESCRIPTION OF THE INVENTION

The invention will now be described in more detail on the basis of the figures. It is to be understood that these figures are for the purpose of clarification and that the skilled person will be aware of modifications, additions and variations that are possible within the scope of this clarification, without deviation from the gist of the invention.

The preferred embodiment of the label and application according to the present invention will be described first with references to the figures. In the figures,

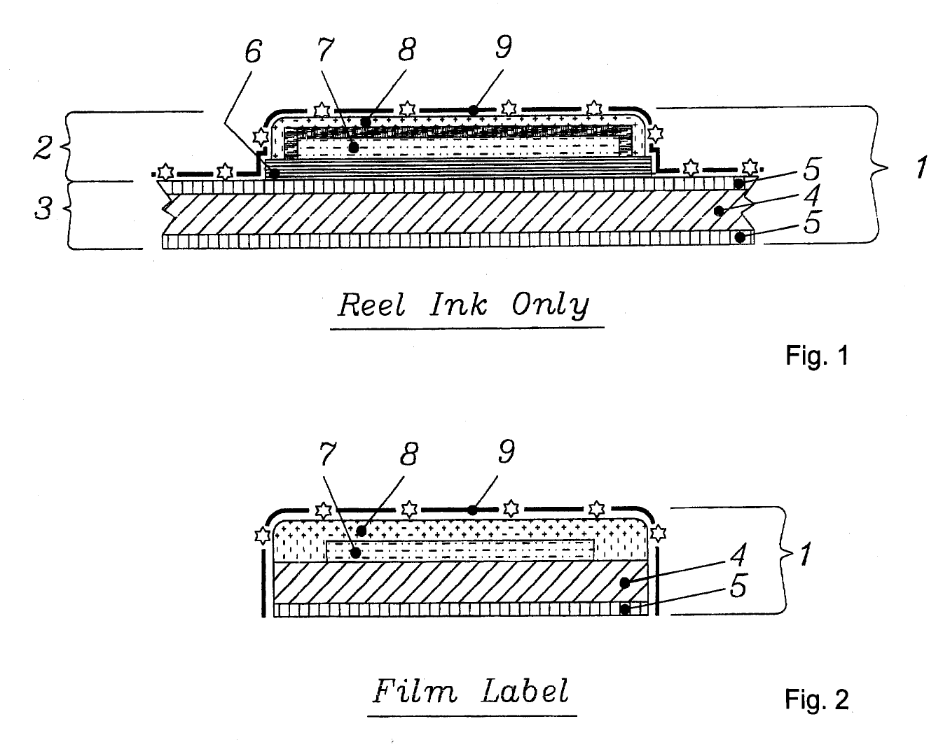

FIG. 1 shows a first embodiment of the invention, wherein a continuous film (3) has been reverse printed on one of its surfaces with an ink-only transfer label (2).

FIG. 2 shows a film label (1), consisting of a backing layer (4) and an ink image (7) as a transfer label, said backing layer (4) having the same size or a slightly larger size than the image (7).

In FIG. 1 the label is printed on a film substrate (3) which may be any thin film or paper carrier, preferably oriented polypropylene (OPP) or a comparable polyester or polyester treated paper. (6) is a protective coating which may or may not be employed, depending on the type of label, and may provide a boundary layer, such as for release properties. (5) is a release material which coats the film. Silicone release layers are well known and commonly used, which release layer is usually applied after the film manufacture. (7) represents all the printed ink material, possibly in multiple layers. Depending on the label graphics and opacity requirements, the ink materials may be as many as eight different colors in one or more layers, some of which may overlay another. (8) represents adhesive, which may comprise more than one layer, depending on the labelled surface uniformity, surface dyne level and rigidity of the article being labelled. It is possible to use only one adhesive layer. The adhesive layer contains either throughout the material, or concentrated on the surface thereof, the inorganic material (9).

Upon application, all of the printed materials (2) are transferred from the release coated film substrate (3). The printed ink materials can be vinyl, acrylic, urethane, polyester resin based, or a combination thereof, and colored with pigments or dyes. The printed adhesive can be a urethane modified acrylic, heat activatable adhesive or any other suitable heat activatable adhesive. It is also possible to use a pressure sensitive adhesive.

The method of label application whereby the printed ink materials are transferred from the film substrate to the article surface, utilizes the tactile characteristics of the heat activated or pressure sensitive adhesive to overcome the bond of the ink layer (7) or protective boundary layer (6) to the film (4), or the release layer (5) thereon.

Protection of the ink against scratching by casual handling as well as insuring its weatherability when subjected to outdoor storage can be achieved, if necessary, with the application of a coating, such as an acrylic based wax water emulsion, an acrylic clear coat, a polyurethane clear coat, or a combination thereof. This is applied by a roll applicator, spray or dip operation. In case a roll applicator is utilized, the transfer surface is supplied from a wet roller with a controlled amount of coating. Control is achieved via a doctor blade. The coating can extend well past the edges of the ink pattern and seals the edges from intrusive moisture.

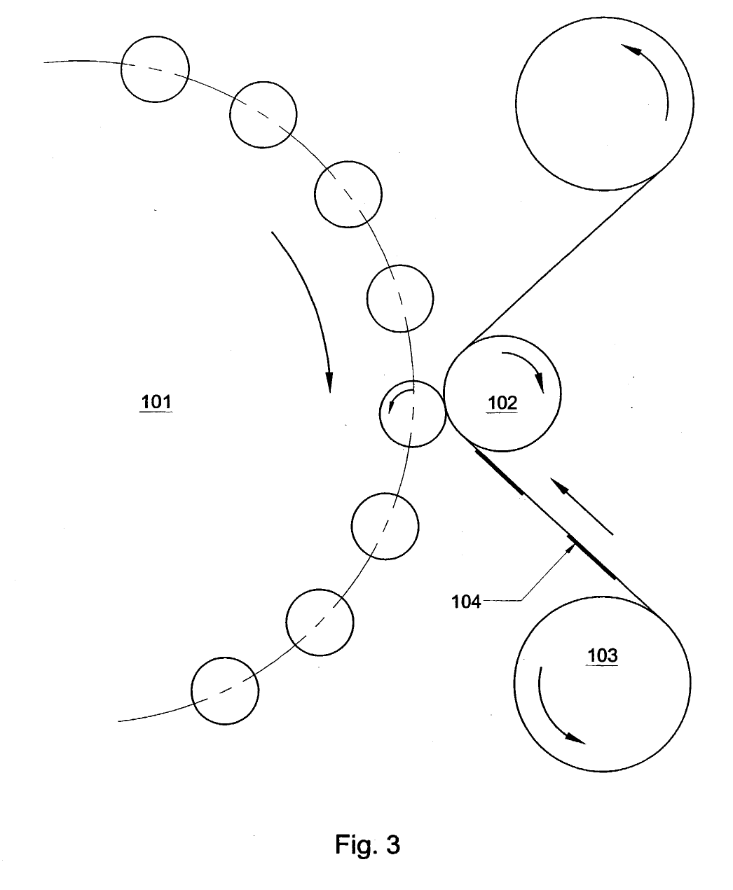

The system as depicted in FIG. 1 will be used in a reel to reel application method, wherein a roll of backing layer, having the labels printed thereon is fed along the application head of the label applicator, as shown in FIG. 3 by way of example. In this figure the container label applicator is schematically shown. Containers are received from a suitable production or cleaning station along a conveyor (not shown). Using known means, the bottles are transferred to a rotating turret table 101. This table moves the containers to the label transfer station 102. During this transport the bottles may be oriented and, it necessary, undergo further treatment. Labels are continuously or intermittently supplied to the label transfer station from reel 103. A backing film, kept under suitable tension, is moved from reel 103, along transfer station 102 to empty web reel 105. On one side of the film, label images 104 are present. At the label transfer station the label images are transferred at high speed from the film to the containers. After transfer the containers are further transported along the turret table to another conveyor (not shown), where they are taken off from the table by suitable means and transported to a further location (post curing (if applicable), storage, pasteurizing, etc.).

It is to be noted that this schematic description of labelling only serves to better understand the principles thereof. Depending on the type of labels, adhesives etc., different criteria apply for the process, such as film tension, heating, pressure application and the like. For these details reference is made to the standard literature on labelling and to the specific patents referred to in this description, the contents of which patents and patent applications are incorporated herein by way of reference. Further it is to be noted, that the above description was based on labelling of bottles. It will be clear that other surfaces may be labelled in a manner based on the same principles.

The presence of the inorganic material in the adhesive ensures that the transfer label is not damaged because of blocking prior to transfer or static build-up when the roll is being slit/die-cut at the printer, or being unwound using the high speeds required for present label applicators, such as those used in breweries for application of labels to beer bottles.

The label material shown in FIG. 2 is utilized in a system based on magazine fed labels, whereby a stack of labels (die cut) usually based on heat activatable or pressure sensitive adhesives, under pressure is fed from a magazine to the application head. In this system both the effects of blocking and static build-up play a role, which can result in an uneven feeding of the labels to the applicator.

In both systems the introduction of the inorganic material prevents problems originating from the presence of water on the surface where the label has to be applied, and provides the superior clarity of the label.

The invention is now elucidated on the basis of examples, which are not intended as limiting the scope of the invention in any way.

### EXAMPLE

A transfer label was prepared by rotogravure printing the following sequence of layers onto a double sided siliconised film of OPP:

1. Protective layer, comprising a transparent acrylic ink

2. One or more (up to eight) ink image layers, comprising of suitable pigmented inks

3. First layer containing white pigment in an acrylic binder

4. Binding layer, providing adhesion between white layers and adhesive

5. Heat activatable adhesive layer

In a first example the adhesive did contain an amount of 0.002 g. (inch)⁻² of silica talc, distributed homogeneously through the adhesive.

In a second (comparative) example the adhesive did not contain the silica talc.

After application of the two different labels, it was noted that the label of the first example showed a much better clarity than the label of the comparative example. Also no defects due to the presence of water were noted during application of the label of the first example, whereas the label of the comparative example showed some visual defects.

1. A label material at least comprising an image layer and an adhesive layer, wherein said adhesive layer is provided with at least one inorganic particulate material having a particle size not exceeding 50 μm and having a refractive index of between 1.4 and 1.6.

2. A label material according to claim 1, wherein the material further comprises a backing layer, having a transfer label, at least comprising said image layer and said adhesive layer releasably attached thereto.

3. A label material according to claim 2, wherein the backing layer is in the form of separate pieces of material, each containing one transfer label of in the form of a roll.

4. A label material according to claim 1-3, wherein the adhesive comprises a pressure sensitive adhesive.

5. A label material according to claim 1-4, wherein the adhesive comprises a heat activatable adhesive

6. A label material according to claim 5, wherein the adhesive combination of heat activatable adhesive and pressure sensitive adhesive.

7. A label material according to claim 1-6, wherein the inorganic material is mainly present in the side of the adhesive layer that will be applied to the surface of the article to be labelled.

8. A label material according to claim 1-7, wherein the inorganic material is either of a synthetic or of a natural origin.

9. A label material according to claim 8, wherein the inorganic material is selected from the group of silicon dioxide and/or silicate containing materials.

10. A label material according to claim 9, wherein the material is selected from the group consisting of diatomite, talc, kaolin and hydrotalcite.

11. A label material according to claim 1-10, wherein the particle size is less than 25 μm.

12. A label material according to claim 1-11, wherein the particle size of the inorganic material is more than 0.5 μm.

13. A label material according to claim 1-12, wherein the amount of said inorganic material is between 0.00001 and 1 g. (inch)⁻².

14. Article, such as a container provided with a label by using the label material according to claim 1-13.

15. Use of at least one inorganic particulate material having a particle size not exceeding 50 μm and having a refractive index of between 1.4 and 1.6 in a label material, at least comprising an image layer and an adhesive layer, for improving various properties thereof.

16. Use according to claim 15, for improving the visual clarity of the label material.
